(19) United States
(12) Patent Application Publication
(10) Pub. No.: US 2007/0162459 A1
(43) Pub. Date: Jul. 12, 2007

(54) System and method for creating searchable user-created blog content

(76) Inventors: Nimesh Desai, Los Angeles, CA (US); David Herman, Remsenburg, NY (US); Daniel Paik, Redondo Beach, CA (US)

Correspondence Address: GREENBERG TRAURIG LLP, 2450 COLORADO AVENUE, SUITE 400E, SANTA MONICA, CA, 90404, US

(21) Appl. No.: 11/331,320

(22) Filed: Jan. 11, 2006

(51) Int. Cl. G06F 17/30

(52) U.S. Cl. 707/10

(57) ABSTRACT

A system and method is provided which allows users to create, upload and post user-created content on a website or device that is searchable and accessible from a different website or device. Each user that adds user-created content to a website or device also defines the search criteria that will be used to search for such content. The system and method further creates a distributed network of independent websites that allows user-created content stored on any of the websites to be searched and accessed from any single website in the distributed network without having to leave that website.

### TECHNICAL FIELD

The present disclosure relates generally to web logs and more particularly to the formation of a distributed network of searchable web logs.

### BACKGROUND

The World Wide Web (“Web”) or Internet is comprised of an expansive network of interconnected computers upon which individuals throughout the world maintain interlinked computer files known as web pages. Web pages contain content that individuals may view and access, such as text, graphics, images, multimedia, sounds, animation, etc., where the location or address of these web pages on the Internet together with their content form a website. Users navigate these websites by means of computer software programs commonly known as Internet browsers. Due to the vast number of Internet websites, many users rely on Internet search engines to find and locate websites containing information sought by the users.

The authors of websites provide information, known as metadata, within the body of the hypertext markup language (HTML) document that defines the web pages. A computer software product known as a web crawler, systematically accesses these websites by sequentially following hypertext links from web page to web page. The web crawler indexes the pages for use by the search engines using information about a website as provided by its address or Universal Resource Locator (URL), metadata, and other criteria found within the website that is provided by the authors. The crawler is run periodically to update previously stored data and to append information about newly created websites. This information compiled by the crawler is stored in a metadata repository or database. Then, the search engines search this repository to identify matches for the user-defined search rather than attempt to find matches in real time.

Users searching for content must rely on the metadata used by a website author or by information extracted by a web crawler in order to locate information on a website corresponding to their search requests. In some situations, content may exist that was not created by a website author or that does not contain readily identifiable information that can be extracted by a web crawler, where previously existing methods do not allow such content to be adequately searched. For instance, this hard-to-search type of content can often be located in web logs.

A web log, also known as and referred to hereafter as a “blog,” can be defined as a journal, publication or posting of information on a website. Blogs often include the personal thoughts posted by an author, i.e., blogger, about a particular subject and are frequently updated by the original poster. Blogging allows multiple individuals to share thoughts and ideas in a community bulletin board environment. Specifically, blogging can simplify the posting of Internet content by automating the publishing of blog content. To that end, blogs provide a means for an individual or group to maintain a website where posting new content is typically accomplished via an Internet browser allowing content to be aggregated easily. In many circumstances, blog posts can be appended with commentary from others who visit the blog. While blogs were initially utilized mostly as journals or to post online editorials or opinions, blogs are now being used as a source of up-to-date news, information and content relating to a vast variety of subjects.

One of the main limitations of blogs and other types of user-created content is that, while website content is widely searchable using well-known Internet search engines, blog content is not readily searchable using these same Internet search engines. Blog content is contained within a frame or portion of a particular website, such that individuals must visit the particular website in order to view the blog content. To access blog content on two separate websites, individuals must separately access each of the websites in order to view the corresponding blog content contained therein. Furthermore, blog content is often generated by an individual who is not the author of the web page on which the blog content is posted, so the blog content may be wholly unrelated to the metadata and descriptions that the author of the web page has provided for the Internet search engines. Thus, an individual who is unaware that the particular website exists will not be able to locate and access the blog content contained therein. This problem also exists for other types of user-created content stored in locations other than web logs. There is clearly a need for a method of enabling user-created content posted on one website or location to be searchable and accessible from other independent locations.

### SUMMARY

According to a feature of the disclosure, a system and method is provided which allows users to create, upload and post user-created content to a website or device such that this user-created content is searchable and accessible from a different website or device. Each user that posts user-created content to a website or device also defines the search criteria that will be used to search for their posted content, regardless of whether the user is in control of creating, authoring or maintaining the website or device on which the content is posted. The present disclosure further teaches a system and method for creating a distributed network of independent websites that allows user-created content stored on any of the websites to be searched and accessed from any single website in the distributed network without having to leave that website.

For purposes of summarizing the disclosure and the advantages achieved over the prior art, certain advantages of the disclosure have been described herein. Of course, it is to be understood that not necessarily all such advantages may be achieved in accordance with any particular embodiment of the disclosure. Thus, for example, those skilled in the art will recognize that the disclosure may be embodied or carried out in a manner that achieves or optimizes one advantage or group of advantages as taught herein without necessarily achieving other advantages as may be taught or suggested herein. All of these embodiments are intended to be within the scope of the disclosure herein disclosed, the disclosure not being limited to any particular preferred embodiment disclosed.

### DRAWINGS

The above-mentioned features and objects of the present disclosure will become more apparent with reference to the following description taken in conjunction with the accompanying drawings wherein like reference numerals denote like elements and in which:

FIG. 1 illustrates a distributed network of devices containing user-created content in accordance with the present disclosure.

FIG. 2 illustrates a representative frame format for a blog content section within a web page in accordance with the present disclosure.

FIG. 3 is an operational flow diagram providing a functional overview for posting user-created content to a website in accordance with the present disclosure.

FIGS. 4A-4D illustrate representative graphical user interface screen shots for entering text, images, audio or video in accordance with the present disclosure.

FIG. 5 illustrates a representative graphical user interface screen shot for entering identifying search criteria in accordance with the present disclosure.

FIG. 6 illustrates a representative graphical user interface screen shot in accordance with the present disclosure.

FIG. 7 illustrates a representative graphical user interface screen shot for user-created content in accordance with the present disclosure.

FIG. 8 illustrates a representative graphical user interface screen shot in accordance with the present disclosure.

FIG. 9 illustrates a representative graphical user interface screen shot showing content search results in accordance with the present disclosure.

FIG. 10 is an operational flow diagram illustrating a functional overview of converting user-created content into Web searchable content in accordance with the present disclosure.

FIG. 11 illustrates a distributed network of blog content-enabled websites in accordance with the present disclosure.

### DETAILED DESCRIPTION

The present disclosure teaches a novel system and method for allowing users to create, upload and post user-created content on a website or device such that this user-created content is searchable and accessible from a different website or device, whereby each user who posts content is enabled to define their own search criteria for their posted content. The present disclosure further teaches a system and method for creating a distributed network of independent websites or devices that allows user-created content stored on any of the websites or devices to be searched and accessed by any of the other websites or devices in the distributed network.

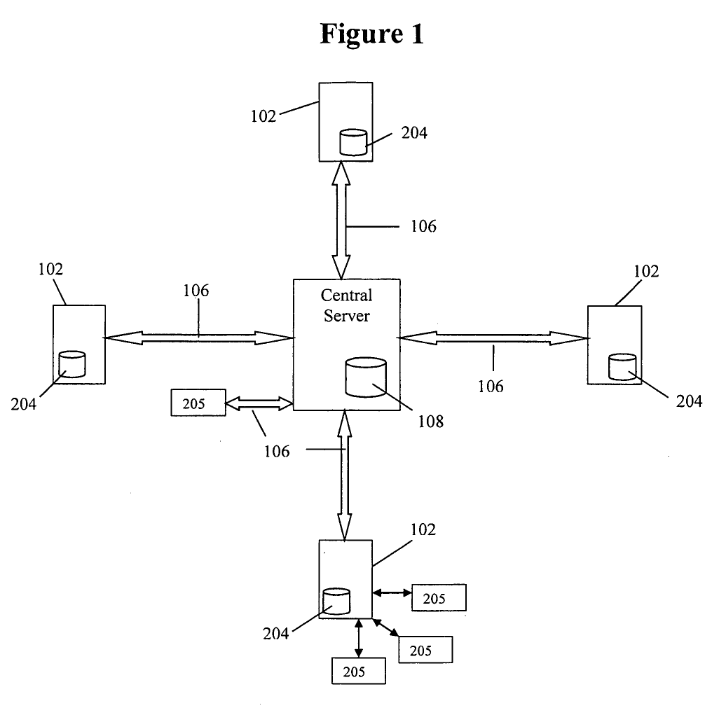

Referring now to FIG. 1, a distributed network 100 according to one embodiment of the present disclosure is illustrated which includes a plurality of independent websites 102 that are interconnected through a centralized server 104. The term website as used herein refers to a database, file or other collection of inter-linked hypertext documents (“web documents” or “web pages”) and associated data or content stored therewith. The content is accessible via a computer network, communication network or other communication medium. The various websites 102 may form part of a larger, distributed informational system, such as the Internet, or may form their own network. In general, a website 102 corresponds to a particular Internet domain name, and includes the content contained in a hosted document or file, such as text, graphics, images, multimedia, sounds, animation, etc. Other types of websites may include, for example, a hypertext database of a corporate “intranet” (i.e., an internal network which uses standard Internet protocols), or a site of a hypertext system that uses document retrieval protocols other than those of the Internet. The term website will include any hosted document.

The websites 102 and their respective content are stored or hosted on corresponding addressable computer systems. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like. While the distributed network 100 is described as including a plurality of websites 102, it is understood that other devices having accessible user-created content stored therewith are contemplated to be within the spirit and scope of the present disclosure.

The websites 102 are communicatively connected to the central server 104 through connections 106, which may comprise a wired connection, such as through a local area network (LAN), a wide area network (WAN), an Internet or other communication network connection, or may comprise a wireless connection, such as through WLAN, WAP, Bluetooth, CDMA, WCDMA, GSM, CDPD, PDC, PHS, TDMA, FLEX, satellite or other wireless transmissions.

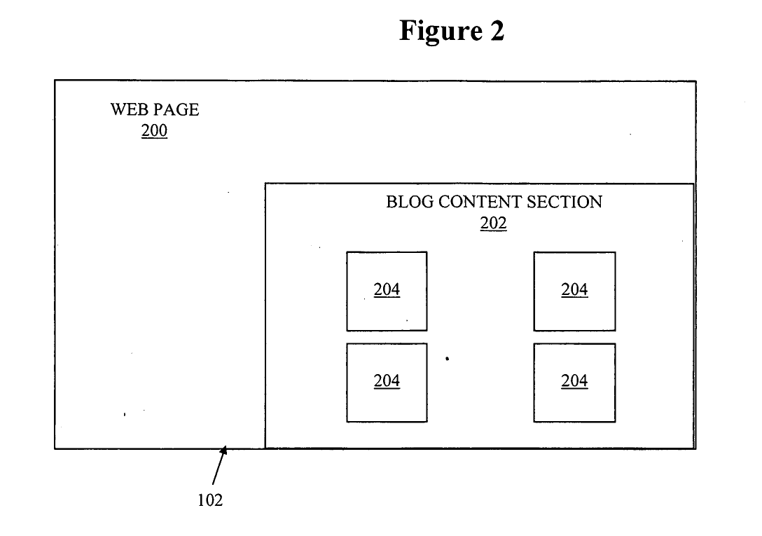

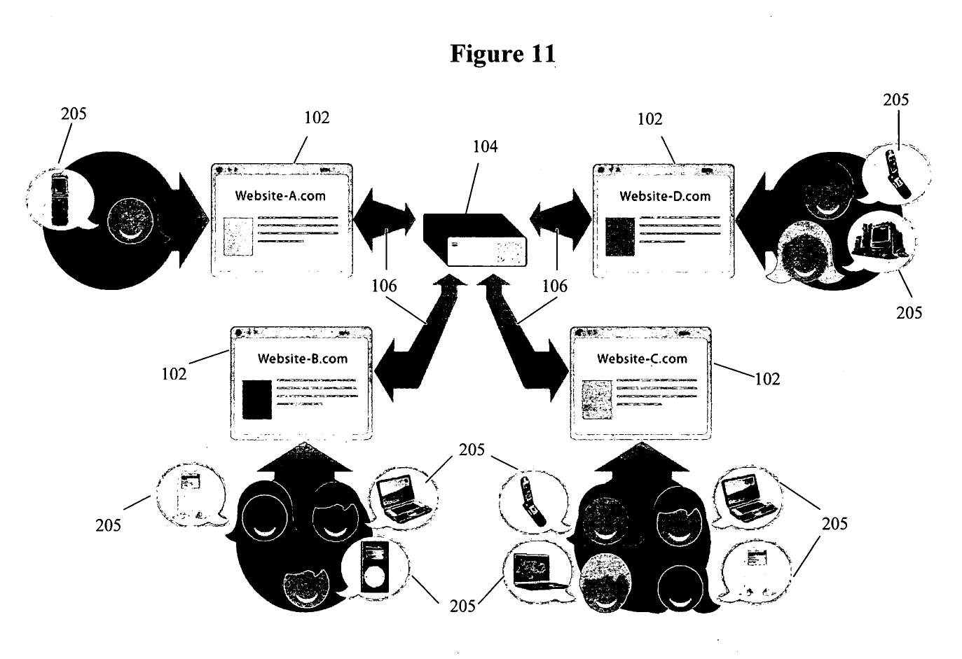

Within a portion of each of the websites 102, in one embodiment at least one web page 200 is provided with a blog content section 202 or frame, as illustrated in FIG. 2. Users or visitors of the website 102 can create, upload, input or otherwise post user-created content 204. User-created content 204 shall refer to text, images, audio, video or any other type of data or content that a user can create, upload, post or otherwise add to a website 102. In one embodiment, the user-created content 204 refers to content that is experienced on a media that is not controlled by the user, such as content added to a website 102 by a user who is not an author or creator of the website 102 and is not able to otherwise affect the searchability of content on the website 102 or the website 102 in general apart from the user-created content 204 that is added. User-created content 204 may be created from any device 205 and may be provided to the website 102 from the same device 205 or from a different device. Any number of different devices 205 can create, upload, post or otherwise add user-created content 204 to a website 102, where such devices include but are not limited to computing systems as defined herein, mobile computing devices, mobile phones, pagers, personal data assistants (PDA), digital audio players, digital video players, digital voice recorders, cameras, etc. User-created content 204 may also be accessed from any device 205 connected to the network 100. Referring now to FIG. 11, an schematic system illustration of a distributed network 100 of blog content-enabled websites 102 is provided showing a number of different users respectively interacting with different websites 102 using different types of devices 205 to either create or experience user-created content 204.

In one embodiment, websites 102 become blog content-enabled with a blog content section 202 by installing a software application program that can either be downloaded to the website 102 from the central server 104 or other source or can alternatively be installed from a computer readable medium. Once a website 102 downloads and installs the blog content software application program, the website 102 becomes part of the distributed network 100 of independent websites 102 that each contain a blog content section 202 capable of containing user-created content therein that can be searched and accessed by any of the other websites 102 or devices 205 in the distributed network 100. All of the blog content-enabled websites 102 in the distributed network 100 are communicatively linked together through the central server 104.

The central server 104 contains a database 108 that maintains a reference to all of the user-created content 204 contained in the blog content sections 202 across all of the respective websites 102 in the distributed network 100. In one embodiment, all interaction between the various websites 102 must go through the central server 104, such that there is no direct connection between any of the blog content-enabled websites 102. The central server database 108 contains an address, pointer or other location identifying data that identifies the particular location on all user-created content 204 contained in the websites 102. Thus, when user-created content 204 on one website 102 is to be accessed by a user on another website 102, the central server database 108 contains the information required for the central server 104 to retrieve the content 204 and forward it to the appropriate website 102 requesting such content. In one embodiment, data that is transmitted between the central server 104 and the websites 102 can be performed using secure or encrypted communication, such as by using Secure Sockets Layer (SSL) (i.e., URLs beginning with https) or the like.

In one embodiment, user-created content 204 may also reside solely on the device 205 without being required to be uploaded to a website 102, wherein the device 205 is communicatively connected to the central server 104 to allow user-created content 204 on the device 205 to be searchable and accessible by other devices 205 and websites 102. User-created content 204 can also be experienced directly on the devices 205 by retrieving the user-created content 204 and sending it directly from the server 104 to the devices 205.

User-Created Content

In one embodiment, content is generally created and posted by a user via the blog content section 202 of a website 102, where the user can input, upload, create, post or otherwise add text, images, audio, video or any other type of data or content to the website 102. It is understood that user-created content 204 can be created on any device, including but not limited to computing systems, mobile phones, handheld devices or any other devices. Each website 102 can have any number of users that post user-created content 204, where the blog content section 202 may be a collaborative effort having user-created content 204 posted from a plurality of users, may have an individual blog content section 202 for each respective user, or may be combination of both individual and collaborative efforts. It is also understood that user-created content 204 is such content that is provided by a user who is not an author or creator of the programming of the website 102 or is not otherwise in control of the media on which the content 204 is experienced.

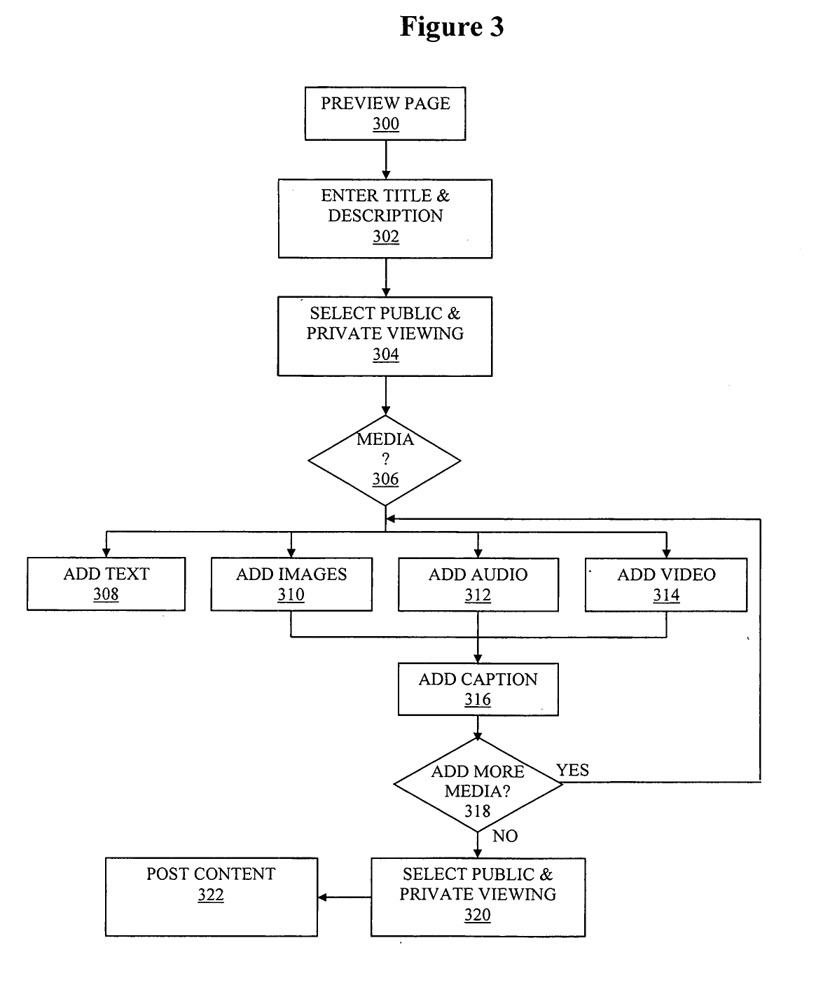

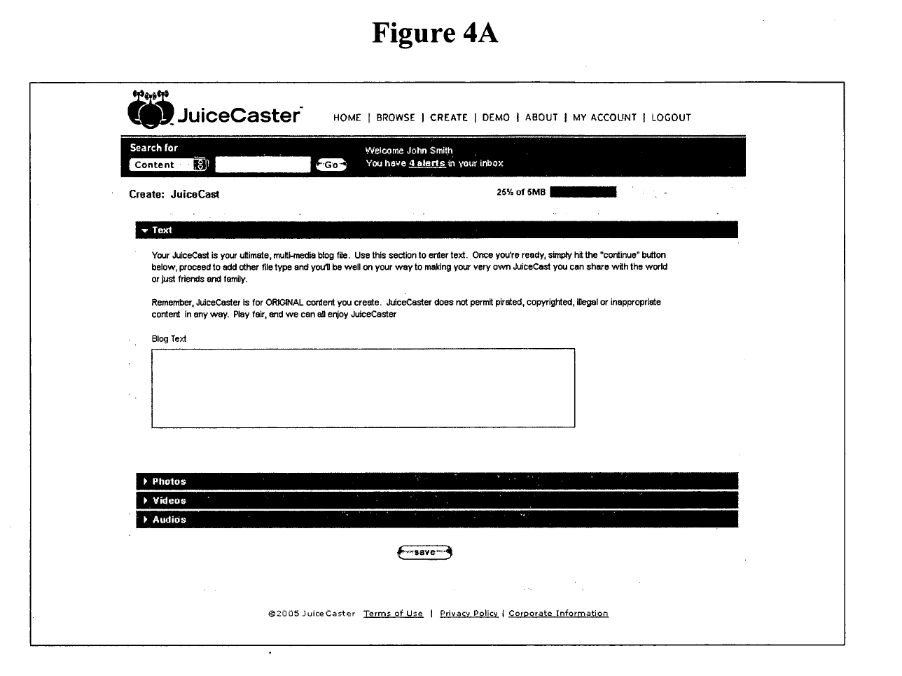

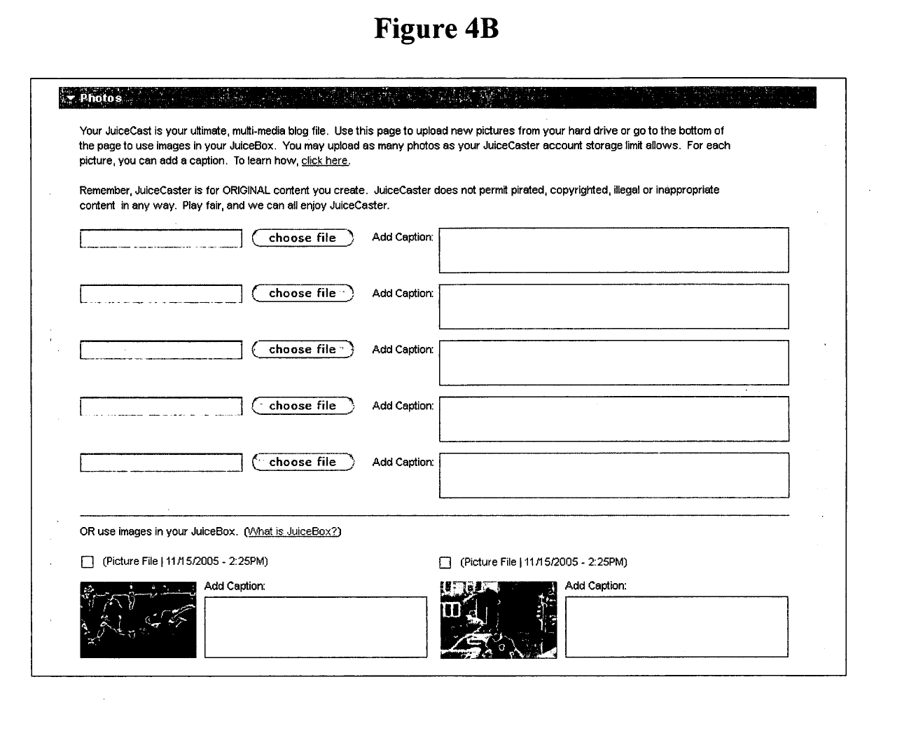

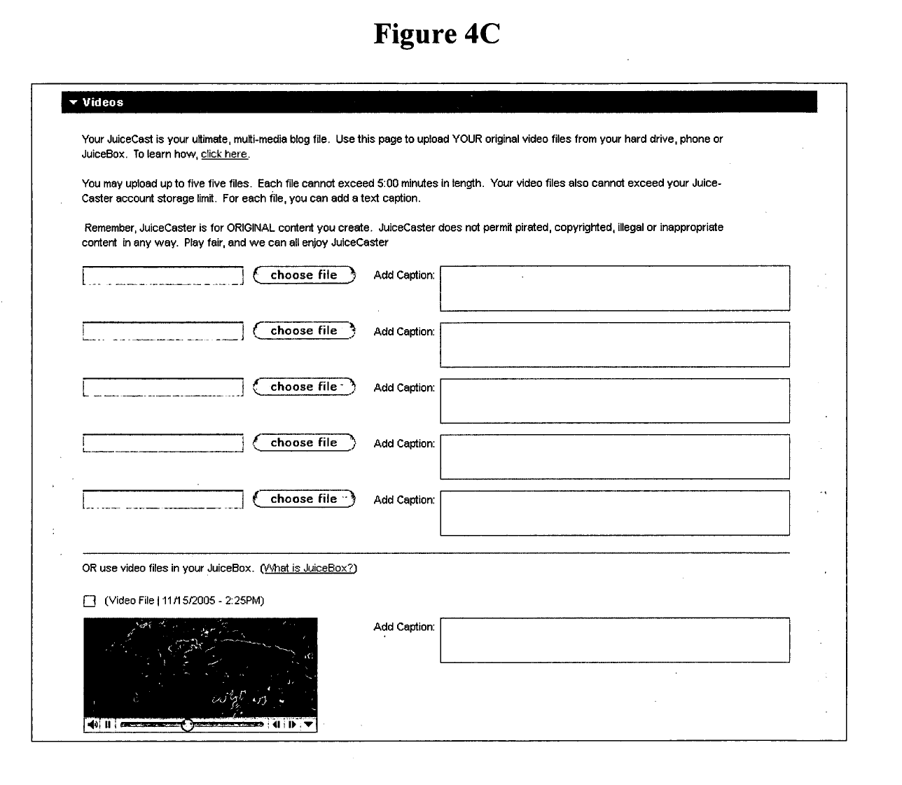

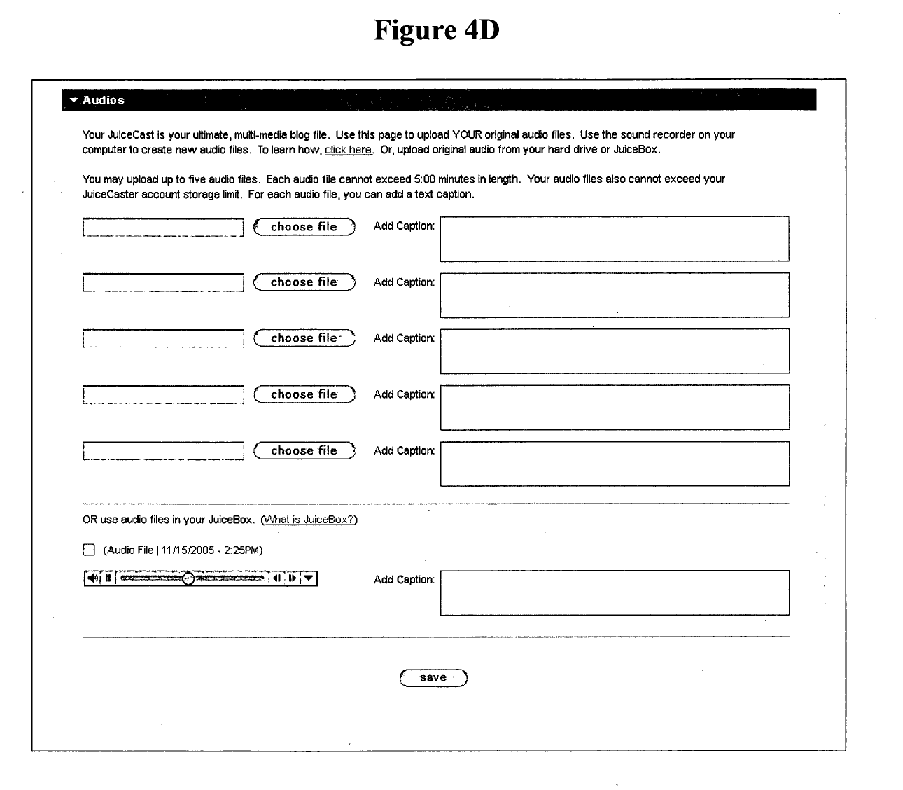

The user-created content 204 for each blog entry may include text, images, audio, video or any combination thereof. Referring now to FIG. 3, a flow diagram is illustrated providing a functional overview for user-created content 204 to be posted to the blog content section 202 of the website 102. From the blog content section 202, the user is able to select the option to create content and is initially provided with a preview page in process block 300. For a given blog entry, a user is provided with an opportunity to enter a title and description in process block 302. The user can also select in process block 304 whether the blog entry will be private or public with other users being permitted to view the blog entry. The user can also specify which users will be allowed to view the blog entry. The user may further select whether other users can post comments or other content in response to the blog entry. The user then determines in process block 306 which media to add as user-created content 204 to the blog entry by selecting whether to add text in process block 306, images in process block 310, audio in process block 312 or video in process block 314. Captions may optionally be added in process block 316 to any of the images, audio or video. It is understood that the particular order in which the information associated with a given blog entry is collected can be varied without departing from the spirit and scope of the present disclosure. Sample screen shots of a graphical user interface for entering text, images, audio or video are illustrated in FIGS. 4A-4D.

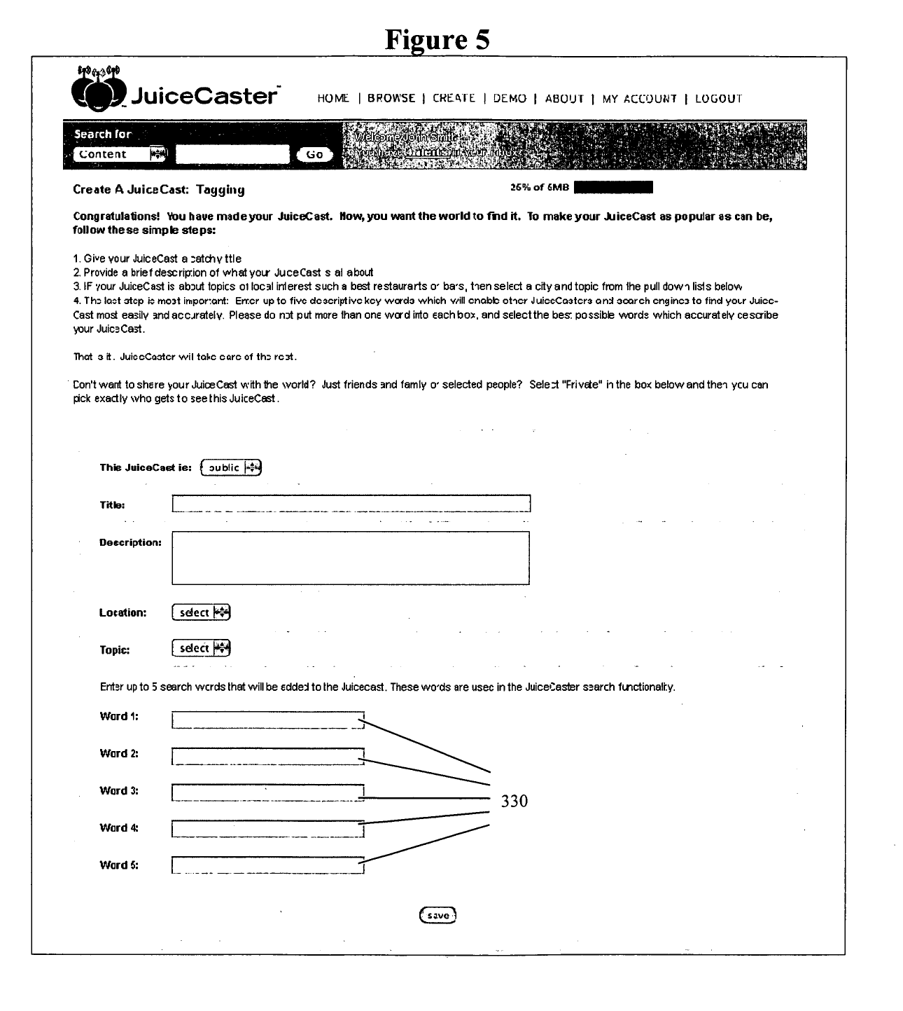

After a determination in process block 318 that all user-created content 204 has been added for a given blog entry, the user is provided with an opportunity to enter identifying search criteria or keywords that tag the user-created content 204 for searching in process block 320. In this manner, the user can create the searchable criteria that will identify and retrieve the content 204 associated with the blog entry they have posted. A sample screen shot in one embodiment of a graphical user interface for entering identifying search criteria in fields is 330 is illustrated in FIG. 5. The search criteria provides a novel manner of allowing user-created content 204 to be searched according to the criteria selected by the user posting the user-created content 204. In one embodiment, a user may also select other identifying criteria, such as a location or topic, for the content 204 from pull-down menus or by direct input. Once all of the content 204 and search criteria have been added for the blog entry, the content 204 is posted to the database 108 on the central server 104 in process block 322 to maintain a record of where such content is located. The central server 104 stores a record, pointer or address for the content 204 on its respective website 102 along with the identifying search criteria or keywords that were entered by the user for this content 204. Thus, when a search is performed by a user for content using keywords, a search of the identifying search criteria stored in the central server database 108 will be performed for a match. The central server 104 will then know where to retrieve the content 204 associated with the identifying search criteria that matches the search terms.

By way of example, if a user posted user-created content 204 that was an audio file containing an interview with the baseball player Derek Jeter, the following parameters may be posted to the central server 104 when user-created content 204 is created:

https://www.txttobuy.com/dev/JuiceCaster/s/newJuiceCast.php parameters:

site: siteA.com

username: dan

password abc

title: My new juicecast

tags: baseball Yankees

location: Los Angeles

top: Sports

text: The Yankees are my favorite team. I really like Derek Jeter . . .

audio_1: (file object)

caption_1: my interview with Derek Jeter

These various parameters are stored in the central server database 108 and may be used to identify the content contained in this particular blog. In this example, a user searching using the keywords “baseball” or “Yankees” would locate the audio file from the example.

Experiencing User-Created Content

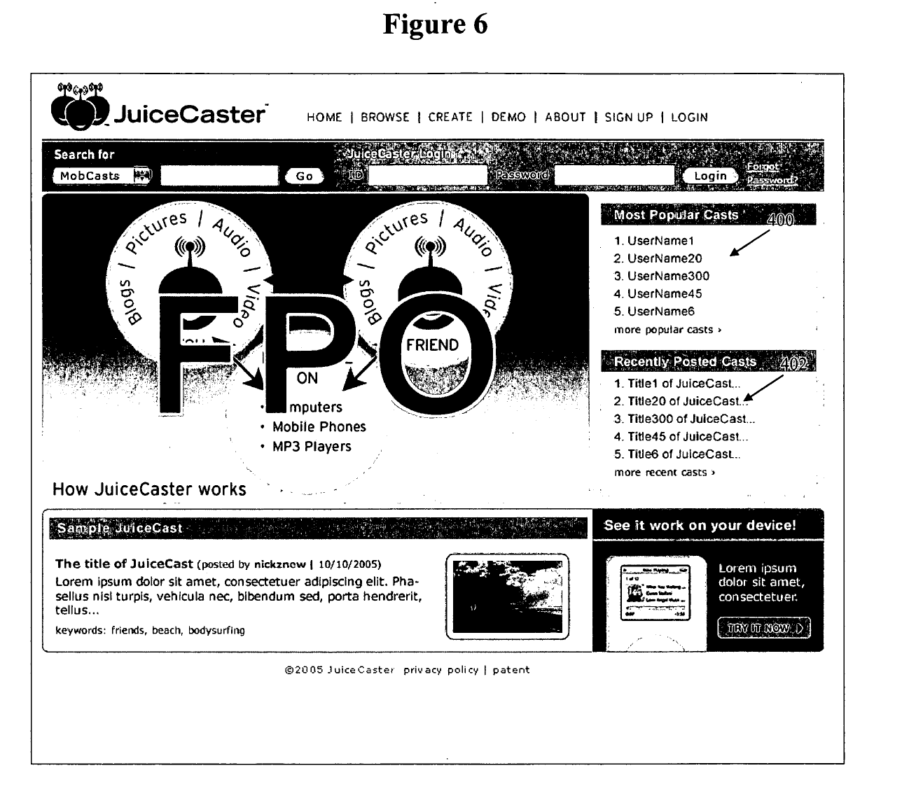

Once user-created content 204 has been created on a website 102 and posted to the central server 104, this user-created content 204 is then accessible to users who visit the website 102 containing such user-created content 204. This content 204 is also accessible to users on other websites 102 in the distributed network 100 who perform searches that match the identifying criteria of the user-created content 204. On blog content-enabled websites 102, visitors to those websites 102 can browse user-created content 204 contained in the blog content sections 202 on any of the websites 102 in the distributed network 100. For instance, in one embodiment, the main web page of the blog content section 202 can display the most popular blog entries 400, most recent blog entries 402 or the most popular authors of blog entries as well some introductory information about the distributed network 100, as illustrated in FIG. 6. In one embodiment, visitors to the websites 102 viewing the blog content sections 202 are merely permitted to view blogs and to search for blogs, where the visitors must sign up as registered users of the distributed network 100 to be permitted access to post any user-created content 204 to the blog content section 202. In one embodiment, registered users may log in to any website 102 on the distributed network 100 that is blog content-enabled.

When a new user becomes registered on a blog content-enabled website 102, information about the user is collected and stored in the central server database 108. The information collected may include any of the following information about the user: a username, mobile phone number, mobile phone provider, email address, full name, postal code or address, gender, date of birth, age verification check, etc. In one embodiment, the registered user is provided with a password that is sent to the mobile phone number provided by the user via SMS message or other similar mobile phone transmission protocol as a security measure to validate the identity of the user. In order to obtain service from most mobile phone service providers, an individual must furnish sufficient identifying information and must be of sufficient age to enter into a service contract with the mobile service provider. Thus, by sending the registered user's password to their mobile phone, the likelihood that the user provided valid information during the registration process in increased. Further, in one embodiment the identity of the user may be verified and/or ascertained from the mobile service provider should the user engage in any fraudulent, illegal or otherwise inappropriate activity when posting content 204 on the website 102.

In one embodiment, each registered user may optionally include a profile that may include any of the following information about the user: a photo of the user, a description or other background information about the user, a rating based on the user-created content 204 the user has posted, favorite authors (i.e., other users who post user-created content 204 on websites 102) in the distributed network 100, etc. This information is posted to the central server database 108 where it can optionally be searched and accessed by other users.

Account Management

Users may experience user-created content 204 by having the content delivered to any number of different types of target devices, including but not limited to computing systems, mobile phones, handheld wireless devices, mp3 or other audio file players, iPods, set top boxes, etc. In the blog content section 202, a manage devices module allows the user to register target devices that can be used to experience the user-created content 204 contained on the websites 102. For instance, makes and models of the devices can be identified by the user so that the central server 104 will be aware of the proper format that the data should be delivered to the respective devices. In one embodiment, the content 204 delivered to the target device may also be formatted to accommodate one or more attributes of the target device. For example, for an application in which the target device is a wireless mobile phone, the data may be formatted by segmenting the data into SMS message segments. The central server 104 can perform any requisite format conversion on retrieved content before forwarding such content to the requesting website 102 or devices 205. Other attributes to consider in formatting the data include the manufacturer, model type, display size, pixel resolution and bandwidth available to the target device. Depending on user's target devices, the blog content section 202 can include dynamically generated icons that correspond to the devices the user actually will be using to experience the content 204.

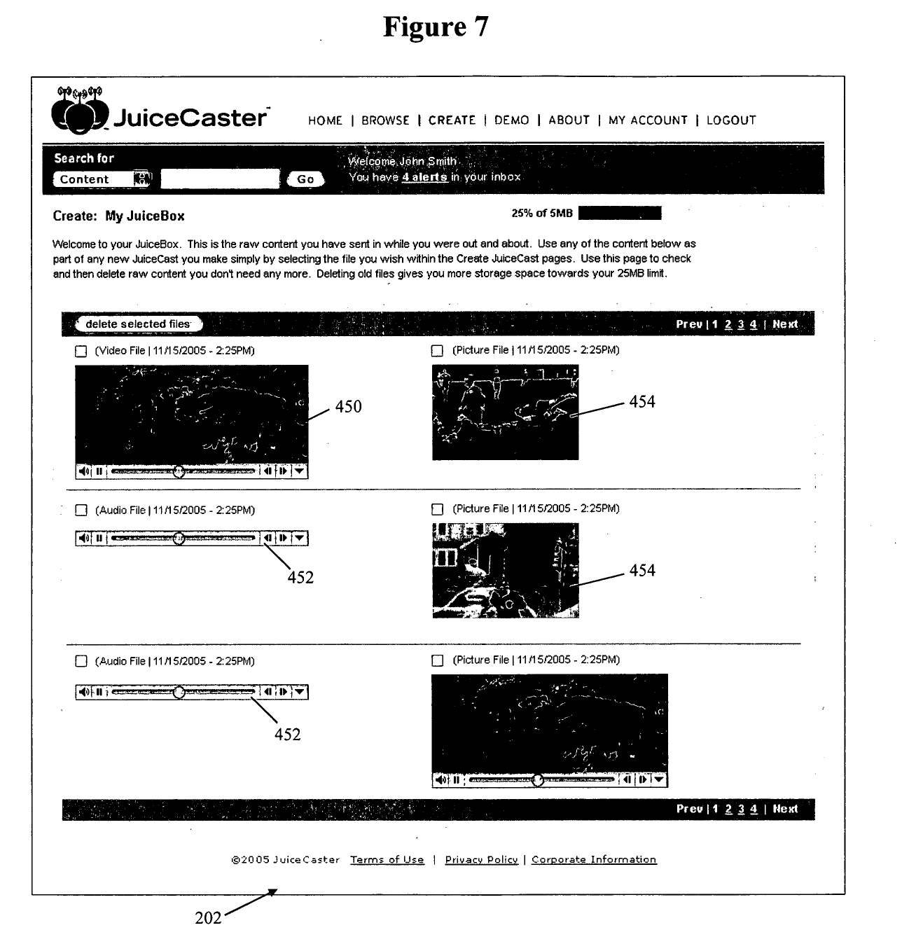

In one embodiment, each registered user may also include an upload web page that is accessible in the blog content section 202 of the website 102 containing all text, images, audio, video or any other type of data or content that a user has uploaded from any device or source but has not yet converted into a posted blog. For instance, as illustrated in the sample GUI screen shot of the upload web page in FIG. 7, video files 450, audio files 452 and images 454 can be uploaded by a user. The user can then utilize this uploaded content at a later date to generate user-created content 204 to be posted to the central server 104.

Blog Alerts

In one embodiment, the distributed network 100 can be configured to generate alerts to users when certain blog events occur. For instance, a user can receive alerts when their favorite author posts a blog, where such alerts can be provided in any form, including but not limited to a text message to the user (e.g., SMS to the mobile phone), an email to the user, or a message box notification in the blog content section 202 on the user's home page.

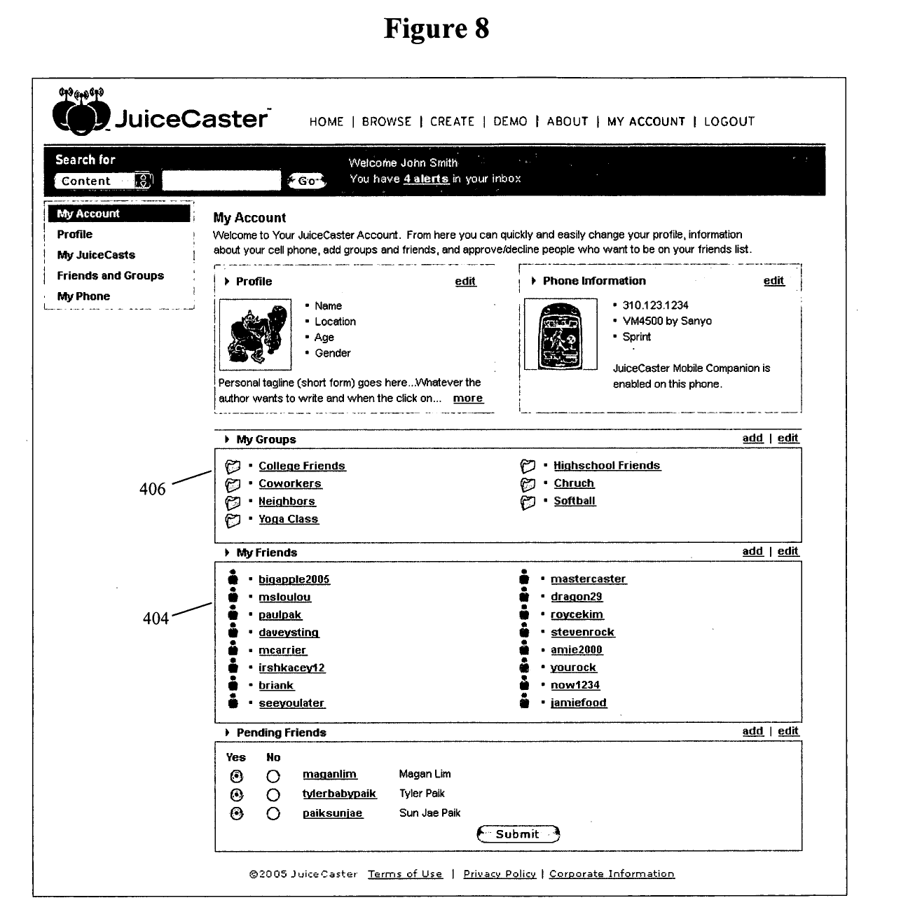

To encourage sharing of user-created content 204 across the distributed network 100, each user may include a list of users identified as “Friends” that will be displayed in the blog content section 202 on the user's home page, as illustrated in the “My Friends” frame 404 in the sample GUI screen shot in FIG. 8. Friends can be added by a user via any number of different methods, such as by using stored contacts from the user's email system to send out invitations to such contacts to join in one embodiment. In another embodiment, users can also add a registered user as a Friend by selecting an “Add as Friend” link on a portion of the other user's home page. The registered user will not be immediately added as a Friend until such a user approves an inquiry request that is sent to the user. In still a further embodiment, a user can “Invite a Friend” where a user can invite unregistered users to be a Friend by entering the unregistered user's name and email address into request fields in the blog content section 202.

In one embodiment, each user can also set up Groups consisting of one or more Friends, as illustrated in the “My Groups” frame 406 in the sample GUI screen shot in FIG. 8. Groups are primarily used to set up private blogs of user-created content 204 that are only viewable by members in a Group. When a user selects to send a private blog to a particular Group, members in the Group will receive an alert (e.g., SMS message, email, message box notification, etc.) that user-created content 204 has been posted by the particular user sending the private blog.

Searching for Blog Content

User-created content 204 contained on any blog content-enabled website 102 can be searched for by implementing a search module appearing in the blog content section 202 of any website 102. Searches are performed by entering keywords or other criteria in the search module appearing in the blog content section 202 of the website 102. The searches can be performed and the search results displayed according to predefined priorities. For instance, in one embodiment, search results having identifying user-defined search criteria stored in the central server database 108 that match the input keywords are displayed first, where those search results can be further prioritized by displaying matching results that were posted by certain users (e.g., displaying results from users in a Friends list first, users in a Group list second, followed by all remaining users). In another embodiment, search results can be prioritized by displaying matching results that match the highest number of identifying criteria first. If no exact matches to user-defined search criteria tags are found, results can optionally be returned that is prioritized by displaying user-created content 204 posted by Friends list first, users in a Group list second, followed by all remaining users. In another embodiment, searches can be performed for any user-created content 204 that has been posted by certain users by searching for criteria such as a user's name, location, handle or registered name, rating, etc.

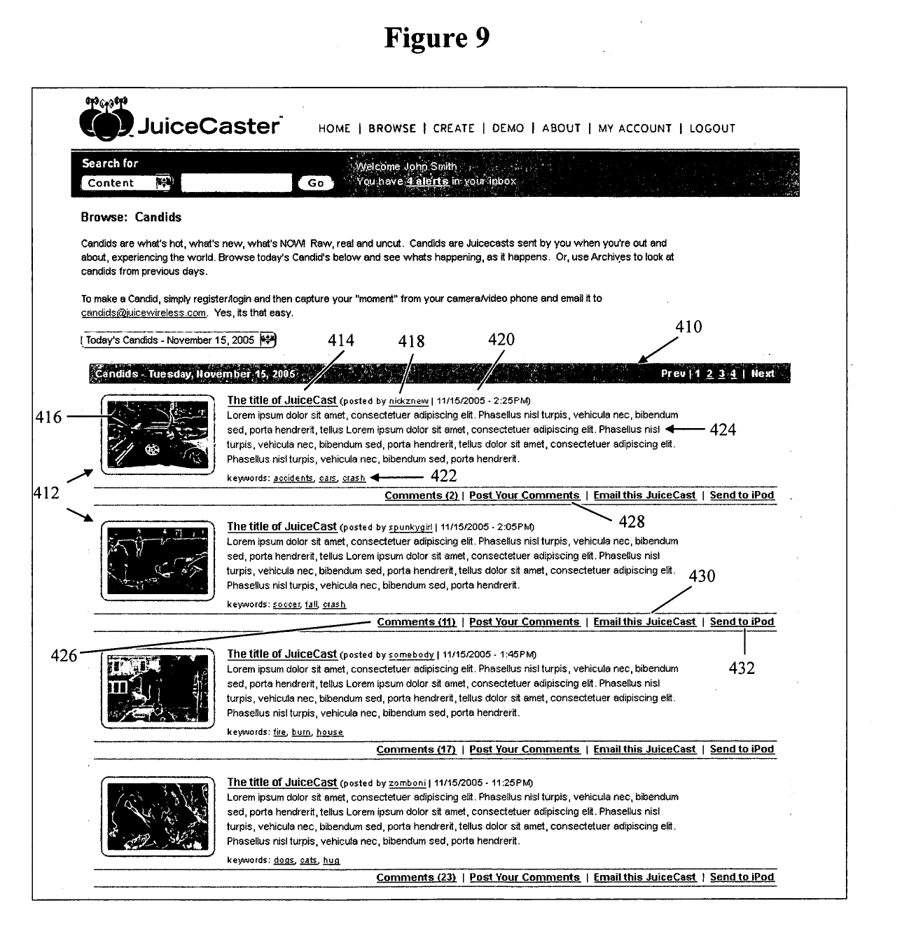

Search requests are sent from the websites 102 or devices 205 to the central server 104. When the central server 104 receives the request, it will process the search functionality and return a result to the website 102 or device 205 that requested the search. It may also be necessary for the central server 104 to perform applicable conversions in the form of the content that is retrieved from its source in one format and may be required to be delivered to another website 102 or target device in another format. In one embodiment, results are returned to the website in a markup language, such as XML or the like. The results contain the actual user-created content 204. The website 102 will then parse the result set that is received and will display the user-created content 204, as illustrated in the sample GUI screen shot in FIG. 9.

If the search results contain a large number of matches, a limited number of matches may be presented to the user per web page, where additional links can be provided to display the remaining search results on additional web pages (e.g. 1, 2, 3, 4, 5, etc.). If a user clicks on one of the additional page links, then the search query will start again where it left off so that it can display the next results. Within a search frame 410, the search results may display the blogs 412 along with information relating to each of the blogs 412, including but not limited to its title 414, data type (text, image, audio, video) icons 416, the author's handle or registered name 418, the time and date of the post 420, search criteria matching keywords 422 and a description 424. A comments link 426 will also allow a user to view comments or other content that other users have posted in response to the respective blog search result, where another link 428 may be provided to allow the user performing the search to post their own comments with the respective blog search result. In one embodiment, users may additionally be provided with tools for sharing particular blog search results with other individuals, such as by activating an email link 430 that will email the blog search result to a desired email address or a “send to device” link 432 that will cause the blog search result to be sent to a target device, such but not limited to a mobile phone, iPod or set top box.

In one embodiment, only user-created content 204 that has been labeled as public is searchable, while content 204 that is labeled as private is not searchable by the users. Private content 204 is also not displayed in the user's normal list of blogs in the blog content section 202 on the user's home page. In one embodiment, private content 204 is only accessible by desired users (i.e., Friends or Groups) that are determined by the user posting the content 204.

Seamless Integration of Website Content

The search results that are returned are also displayed in the blog content section 202 of the website 102 from which the search was requested. In this manner, a user can retrieve user-created content 204 that is located on another website in the distributed network 100 without ever leaving the website 102 or having to jump from website 102 to website 102. In this manner, all of the user-created content 204 contained on all of the various blog content-enabled websites 102 is seamlessly integrated to appear as though such content 204 from the various websites 102 is located on the same website 102 on which the user is visiting.

For instance, if a user wanted to locate stories or opinions about a particular baseball player, e.g., Derek Jeter, that appear in websites, the user would typically in the past have been required to entire a keyword search into an Internet search engine to locate various different web pages that contained metadata related to baseball and Derek Jeter. In order to find information in blogs or other user-created content sections of websites or devices, the user would have then been forced to visit website after website to look for various different stories and other content that may be contained in blogs on the various websites that relate to Derek Jeter. Since blog content was not previously adequately searchable from external websites, this process could become cumbersome for a user. To the contrary, the present disclosure provides a system and method for such blog content related to stories on a particular topic that appear in blogs on various websites 102 to be searchable and accessible from a single website 102 on the distributed network 100.

Creating Web Searchable Content

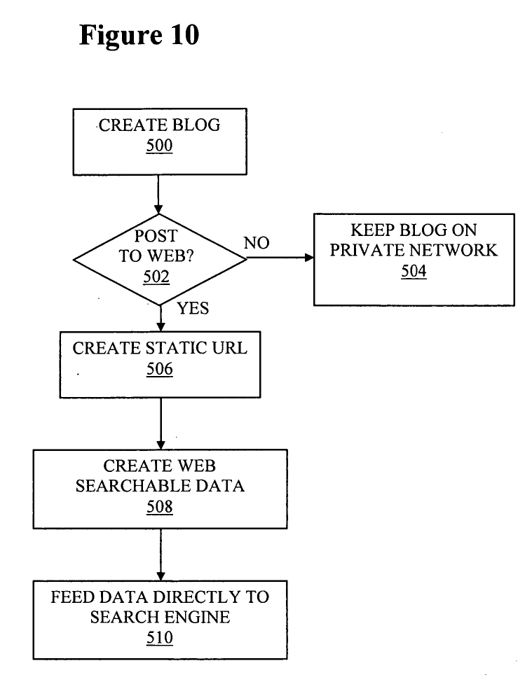

While user-created content 204 is accessible and searchable by all blog content-enabled websites 102 in the distributed network 100, another embodiment further allows such user-created content 204 to become Web searchable by Internet search engines to allow users to locate such content from websites that are not blog content-enabled. Referring now to FIG. 10, a operational flow diagram is illustrated providing a functional overview of converting user-created content 204 into Web searchable content. After a blog is created in process block 500 by a user a posting user-created content 204 according the present disclosure, the user selects in process decision 502 whether to post the content to the Web outside of the distributed network 100. If the user decides to keep the blog from being searchable outside of the network 100, the blog is kept private in process block 504 so that only the user or other websites 102 in the distributed network 100 can access the blog. If the user selects to post the blog to the Web, a static Uniform Resource Locator (URL) is created for the blog in process block 506. A URL is a unique address that fully specifies the location of the blog content on the Internet. The blog content 204 is then utilized to create Web searchable data in process block 508 that is typically relied upon by Internet search engines, such as but not limited to titles, subtitles, metadata and other information known to those skilled in the art to be relied upon by Internet search engines. This web searchable data can also be optimized in a way that Internet search engines classify the data as having a higher priority search result. In process block 510, the web searchable data and URL for the blog content 204 are then communicated directly to Internet search engines (e.g., Google®, Yahoo®, etc.) to increase the likelihood that such blog content 204 will be appear in Web-based searches from websites located outside of the distributed network 100.

While the present disclosure is described in many of the embodiments herein as a distributed network of websites 102, it is understood that other devices 205 may be utilized in the network 100 in conjunction with or in place of the websites 102. In one embodiment, the distributed network 100 may include any collection of electronic or digital devices communicatively connected together that contain user-created content or digital files thereon that are experienced on a media not created or under the creative control of the user posting the user-created content. For example, the devices 205 could be set top boxes having user-created content associated therewith that are communicatively connected through a cable or satellite network, where a user of one set top box could perform a search according to the methods described herein using a navigation module associated with the set top box to locate user-created content contained on other set top boxes in the network 100. By way of further example, the network devices 205 could be satellite radio devices containing user-created content thereon, such as audio files or images recorded by a user, where the user of the satellite radio devices could search for user-created content stored on another satellite radio device in the network 100 using the search methods described herein.

The present disclosure, as would be known to one of ordinary skill in the art could be produced in hardware or software, or in a combination of hardware and software. Various components of the system and method according to the present disclosure may be produced in a single computer system having separate elements or means for performing the individual functions or steps described or claimed or one or more elements or means combining the performance of any of the functions or steps disclosed or claimed, or may be arranged in a distributed computer system or information processing system or information processing unit, interconnected by any suitable means as would be known by one of ordinary skill in art.

The system and method described in the present disclosure are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer, as would be known to one of ordinary skill in the art. The computer medium which may be used to hold or contain the computer program product, may be a fixture of the computer such as an embedded memory or may be on a transportable medium such as a disk, as would be known to one of ordinary skill in the art.

The present disclosure is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium or product allowing a computer to read data, instructions, messages or message packets, and other computer readable information from the computer readable medium. The computer readable medium may include non-volatile memory, such as ROM, Flash memory, floppy disk, Disk drive memory, CD-ROM, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network, that allow a computer to read such computer readable information.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A networked device for linking a plurality of independent websites having web logs and allowing user-created content contained on the web logs in any of the websites to be searchable and accessible from any of the other websites, the networked device comprising:
a processor;
a memory;
a database contained in the memory having information stored therein relating to user-created content posted on a web log in at least one of the plurality of websites, wherein the stored information includes user-defined search criteria for the respective posted user-created content; and
a search engine executable by the processor on the networked device for searching the database for user-defined search criteria that at least partially matches a search request received by the networked device from a website, retrieving the matching user-defined content from the website on which such content is posted, and forwarding the retrieved user-defined content to the requesting website.

2. A distributed network of web logs comprising:
a plurality of distinct web logs containing user-created content;
a centralized database communicatively connected to the plurality of web logs, wherein the centralized database contains information relating to the user-created content contained in the web logs,
wherein the user-created content on a first web log is accessible into a second web log without leaving the second web log.

3. A system comprising:
a processor;
a network connection; and
a storage unit to contain information related to logs of user-created content to be contained in separately hosted documents, wherein the user-created content of a log in a first document is accessible into a second separately hosted document.

4. The system of claim 3, wherein at least one of the separately hosted documents includes a web site.

5. The system of claim 4, further comprising a search engine accessible by one or more of the separately hosted documents to allow user-created content of a log in the first document to be searchable from the second document via the information related to the logs of user-created content to be stored in the storage unit.

6. The system of claim 5, wherein the user-created content is non-textual.

7. The system of claim 6, wherein at least part of the user-created content comprises multi-media.

8. The system of claim 3, wherein one or more of the separately hosted documents further comprise a user interface for a user to enter the information related to the logs of user-created content to be stored in the storage unit of the system, the information to be used for searching the logs of user-created content as to be contained on the separately hosted documents.

9. A system comprising:
a processor;
a network connection; and
a storage unit to contain data to host a website containing a web log forum for receiving content posted from at least one user, wherein the content in the web log forum is searchable from a second website.

10. A system comprising:
a processor;
a network connection; and
a storage unit to contain information related user-created content to be contained in digital files in electronic devices, wherein the user-created content of a first electronic device is accessible by a second electronic device.

11. The system of claim 10, wherein the user-created content is content that is created by a specific user and that is experienced on a media not under the control of the user.

12. A distributed network of electronic devices comprising:
a plurality of distinct electronic devices containing user-created content, wherein user-created content is content that is created by a user of a particular electronic device and that is experienced on a media on the particular electronic device that is not created or authored by the user;
a centralized database communicatively connected to the plurality of electronic devices, wherein the centralized database contains information relating to the user-created content contained in the electronic devices,
wherein the user-created content on a first electronic device is accessible into a second electronic device.

13. A method comprising:
receiving content provided by a user in a web log on a website;
receiving user-defined search criteria for the content; and
sending the user-defined search criteria to a first system, the user-defined search criteria to be used to identify the content provided by the user in response to a search query submitted from a separate system.

14. The method of claim 13, wherein the search query is to be submitted to the first system from a second system.

15. The method of the claim 14, further comprising, in response to the request from the second system, providing the content provided by the user.

16. The method of claim 15, wherein the request from the second system is received via a website of the second system, and the providing the content further comprises providing the content to the website of the second system.

17. The method of claim 13, wherein the first system and any websites connected thereto form a private network, said method further comprising:
posting the content and search criteria on the private network; and
separately posting the content on a public network.

18. The method of claim 17, wherein the public network posting includes the step of creating a static Uniform Resource Locator (URL) based on the content and the website on which the content was posted.

19. The method of claim 18, wherein the URL is searchable based on the user-defined search criteria.

20. The method of claim 17, wherein the public network posting includes the step of converting the content and user-defined search criteria into a format searchable by public network search engines.

21. The method of claim 17, wherein the content is separately searchable from the private network and the public network.

22. A method comprising:
receiving information identifying a location of user-created content posted on a first website;
receiving search parameters corresponding to the user-created content, as defined by a user creating the user-created content, the search parameters to be used to identify the user-created content in response to receiving a search query;
receiving a search query from a second website; and
in response to the search query at least partially matching the search parameters as defined by the user of the user-created content, providing to the second website information relating to the user-created content posted on the first website.

23. A method comprising:
receiving content created by a user of a first electronic device;
receiving user-defined search criteria for the content; and
sending the user-defined search criteria to a first system, the user-defined search criteria to be used to identify the content provided by the user in response to a search query submitted from a second electronic device.

24. A method comprising:
receiving information identifying a location of user-created content contained on a first electronic device;
receiving search parameters corresponding to the user-created content, as defined by a user creating the user-created content, the search parameters to be used to identify the user-created content in response to receiving a search query;
receiving a search query from a second electronic device; and
in response to the search query at least partially matching the search parameters as defined by the user of the user-created content and providing to the second electronic device information relating to the user-created content contained on the first electronic device.

25. A machine-readable medium having program instructions stored thereon executable by a processing unit for performing the steps of:
receiving information identifying a location of user-created content posted on a first website;
receiving search parameters corresponding to the user-created content, as defined by a user of the user-created content, the search parameters to be used to identify the user-created content in response to receiving a search query;
receiving a search query from a second website; and
in response to the search query at least partially matching the search parameters as defined by the user of the user-created content, providing to the second website information relating to the user-created content posted on the first website.

26. A machine-readable medium having program instructions stored thereon executable by a processing unit for performing the steps of:
receiving content provided by a user in a web log on a website;
receiving user-defined search criteria for the content; and
sending the user-defined search criteria to a first system, the user-defined search criteria to be used to identify the content provided by the user in response to a search query submitted from a separate system.

27. A system comprising:
means for receiving information identifying a location of user-created content posted on a first website;
means for receiving search parameters corresponding to the user-created content, as defined by a user of the user-created content, the search parameters to be used to identify the user-created content in response to receiving a search query;
means for receiving a search query from a second website; and
means for, in response to the search query at least partially matching the search parameters as defined by the user of the user-created content, providing to the second website information relating to the user-created content posted on the first website.

28. A system comprising:
means for receiving content provided by a user in a web log on a website;
means for receiving user-defined search criteria for the content; and
means for sending the user-defined search criteria to a first system, the user-defined search criteria to be used to identify the content provided by the user in response to a search query submitted from a separate system.
